(19) United States
(12) Patent Application Publication
(10) Pub. No.: US 2024/0178907 A1
(43) Pub. Date: May 30, 2024

(54) MULTIPLE COORDINATED DECODING & FORWARDING REPEATERS

(71) Applicant: MEDIATEK INC., Hsinchu (TW)

(72) Inventor: Lung-Sheng Tsai, Hsinchu (TW)

(21) Appl. No.: 18/517,144

(22) Filed: Nov. 22, 2023

Related U.S. Application Data
(60) Provisional application No. 63/384,958, filed on Nov. 24, 2022.

(51) Int. Cl. H04B 7/155; H04W 72/044; H04W 72/20

(52) U.S. Cl. CPC H04B 7/15542; H04W 72/044; H04W 72/20

(57) ABSTRACT

A base station determines N sets of data signals to be transmitted to a UE via N repeaters. Each set of the N sets of data signals is associated with each of the N repeaters and carries data of a plurality of layers. The base station transmits first control information to the N repeaters. The first control information indicates a first resource allocation for data reception at each repeater on a first time-frequency resource. The base station transmits N resource mapping rules to the N repeaters. The N resource mapping rules indicate each mapping from the first resource allocation to a second resource allocation for forwarding each of the N sets of data signals. Each of the N sets of data signals is received at each repeater on the first time-frequency resource. Each of the N sets of data signals is forwarded on a second time-frequency resource.

### CROSS-REFERENCE TO RELATED APPLICATION(S)

This application claims the benefits of U.S. Provisional Application Ser. No. 63/384,958, entitled “COOPERATION OF MULTIPLE COORDINATED D AND F RELAYS” and filed on Nov. 24, 2022, which is expressly incorporated by reference herein in its entirety.

### BACKGROUND

### Field

The present disclosure relates generally to communication systems, and more particularly, to techniques of decoding & forwarding data at a repeater.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a base station. The base station determines N sets of data signals to be transmitted to a user equipment (UE) via N repeaters. Each set of the N sets of data signals is associated with each of the N repeaters and carries data of a plurality of layers. N is an integer greater than 1. The base station transmits first control information to the N repeaters. The first control information indicates a first resource allocation for data reception at each repeater on a first time-frequency resource. The base station transmits N resource mapping rules to the N repeaters. The N resource mapping rules indicate each mapping from the first resource allocation to a second resource allocation for forwarding each of the N sets of data signals. Each of the N sets of data signals is received at each repeater on the first time-frequency resource. Each of the N sets of data signals is forwarded on a second time-frequency resource. The second resource allocations for the N repeater are non-overlapping in at least one of time domain, frequency domain, and spatial domain. The base station transmits, to the N repeater, the N sets of data signals on the first time-frequency resource according to the first resource allocation.

In another aspect of the disclosure, a method, a computer-readable medium, and an apparatus are provided. The apparatus may be a UE. The UE receives control information for decoding N sets of data signals transmitted by N repeaters. Each set of the N sets of data signals is associated with a respective one of the N repeaters, where N is an integer greater than 1. The UE receives RF signals transmitted from the N repeaters on N second time-frequency resources. The UE decodes the N sets of data signals from the RF signals based on the control information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a distributed downlink MIMO transmission.

FIG. 8 is a diagram illustrating downlink MIMO transmission from a base station to a UE via one or more repeaters.

FIG. 9 is a diagram illustrating a mapping rule that maps a resource allocation (RA) on a first time-frequency resource to RA on a second time-frequency resource.

FIG. 10 is a diagram illustrating a mapping rule that maps data transmission in a first PDSCH to data transmission in a second PDSCH.

FIG. 11 is a diagram illustrating a MIMO transmission using a space-division multiplexing (SDM) configuration or a frequency division multiplexing (FDM) configuration.

FIG. 12 is a diagram illustrating a MIMO transmission using a time-division multiplexing (TDM) configuration.

FIG. 13 is a flow chart of a method (process) for transmitting data signals.

FIG. 14 is a flow chart of a method (process) for decoding data signals.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

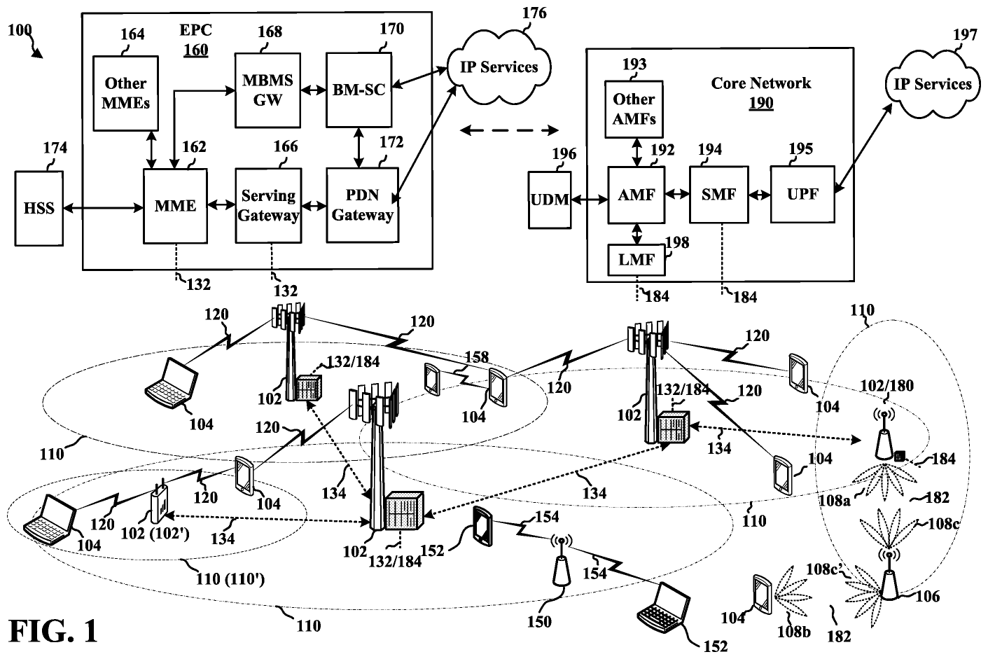

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102″ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102″ may employ NR and use the same 5 GHZ unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

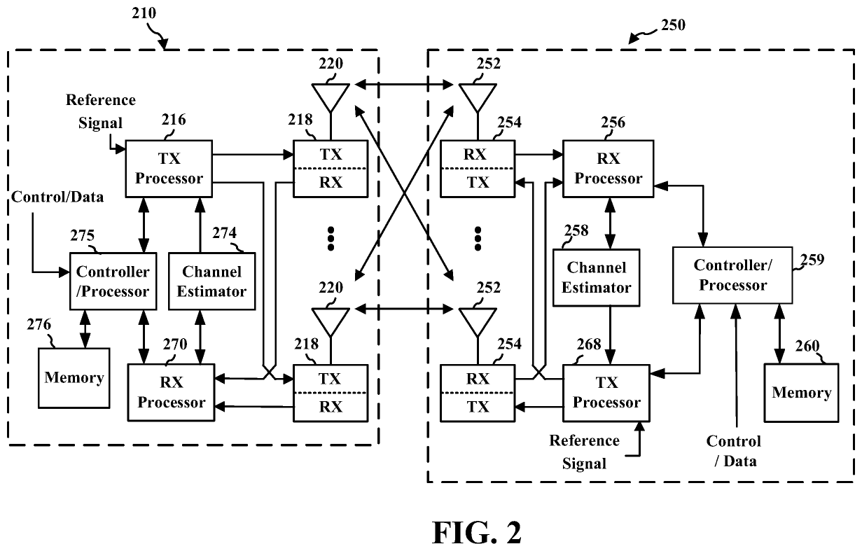

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs: and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs: and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

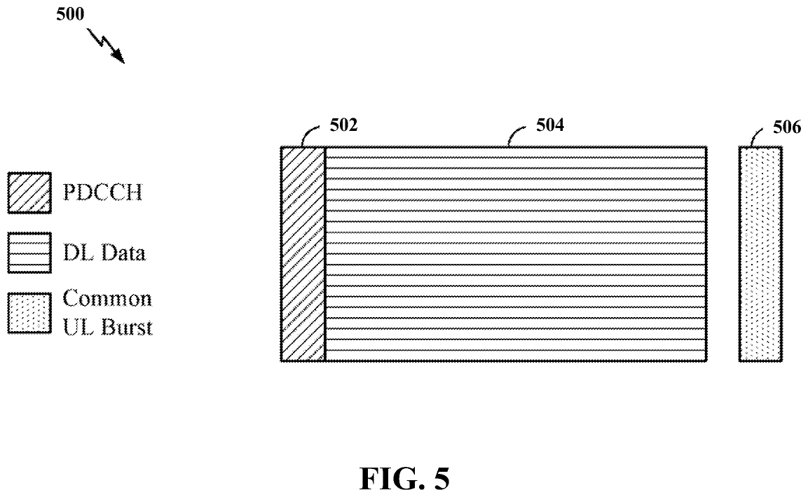

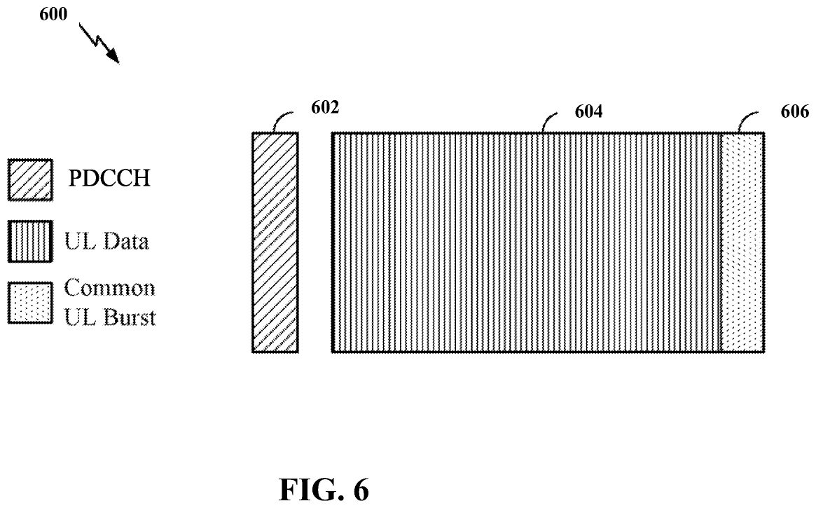

A single component carrier bandwidth of 100 MHz may be supported. In one example, NR resource blocks (RBs) may span 12 sub-carriers for each RB with a sub-carrier spacing (SCS) of 60 KHz over a 0.25 ms duration or a SCS of 30 kHz over a 0.5 ms duration (similarly, 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

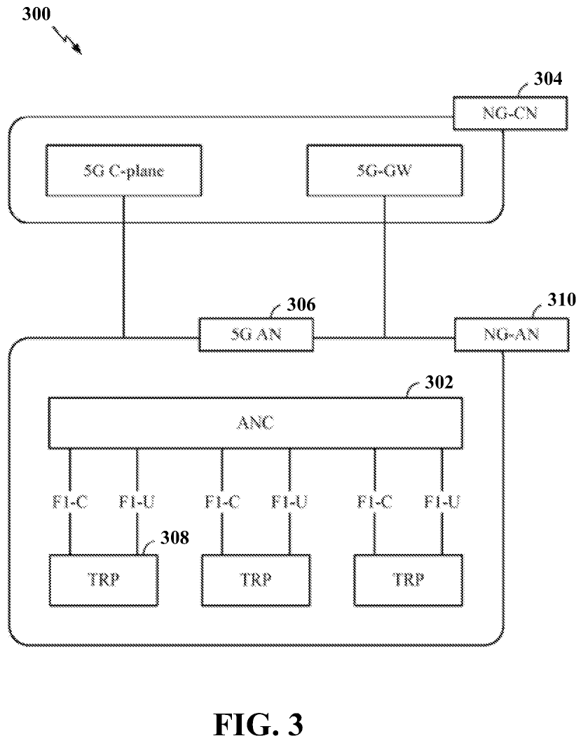

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

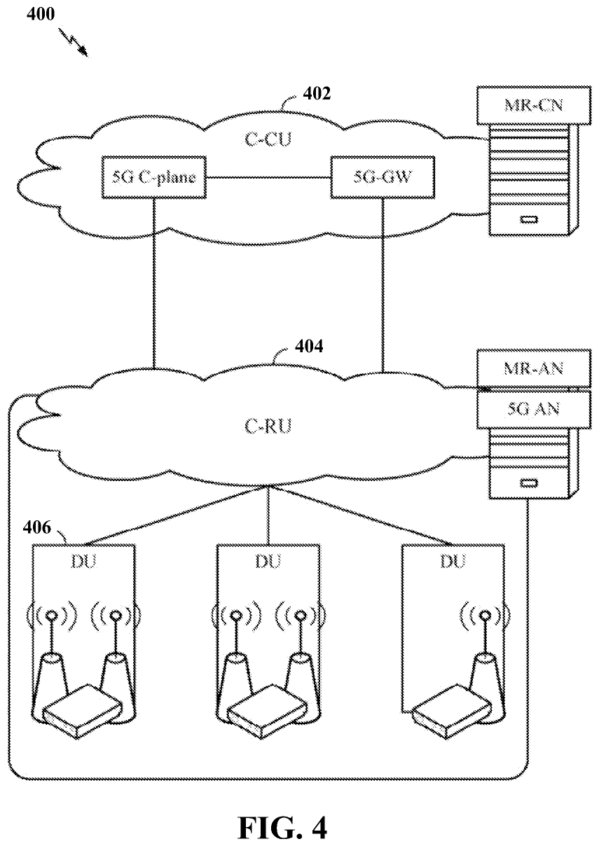

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

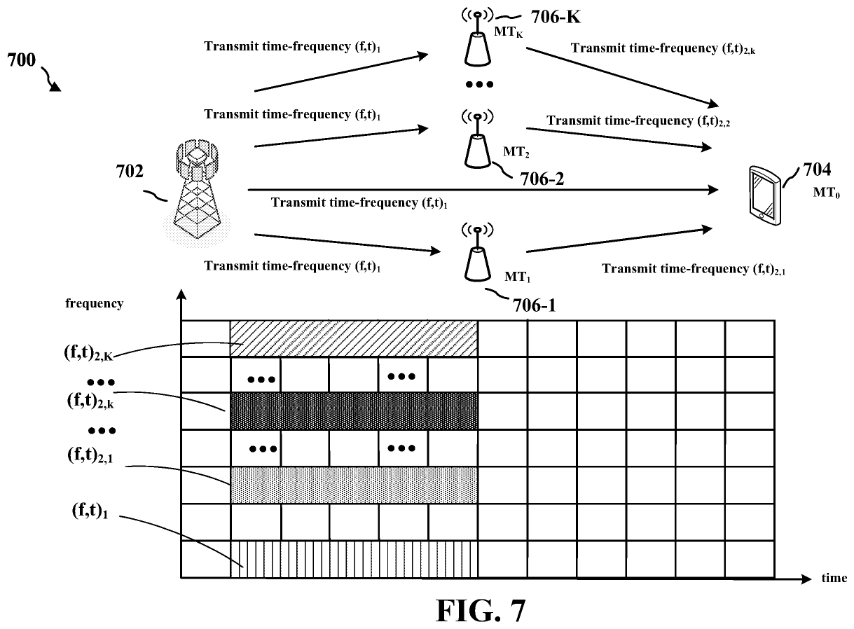

FIG. 7 is a diagram 700 illustrating a distributed downlink MIMO transmission. A base station 702 and a UE 704 communicate with each other via one or more repeaters 706-1, 706-2, . . . , 706-K. The repeaters may be wireless devices such as mobile phones, fixed CPEs, and wireless routers. In this example, there are K repeaters (K is an integer and K≥ 1). The UE 704 and the K repeaters 706-1, 706-2, . . . , 706-K are connected together to form a high-rank MIMO transmitter/receiver network to expand the channel rank.

As described infra, a repeater receives RF signals on a first frequency band f₁ through a first PDSCH, decodes modulated symbols of the first PCSCH to obtain information bits carried by the first PDSCH, re-encodes the information bits and shifts the RF carrier of the RF signals to a second frequency band f₂, and then transmits the shifted RF signals on the second frequency band f₂ through a second PDSCH. Each frequency band is an interval in frequency domain. In particular, the repeater may be a frequency translating repeater. The repeater may also be a time delaying repeater, which receive RF signals and then re-transmit the received RF signals after some time delay. Further, the repeater may receive RF signals in a first time-frequency resource, translate the received RF signals to a second time-frequency resource, and then transmit the translated RF signals. In particular, the first time-frequency resource may be orthogonal with the second time-frequency resource.

Using (f, t) to denote the time-frequency resources: (f, t)₁ denotes the time-frequency resource used by the base station for transmitting and receiving RF signals. (f, t)_{2,k} denotes the resources used by a particular repeater MTₖ (k is an integer and 1≤k≤ K) to transmit RF signals to the UE. As such, (f, t)_{2,1} indicates the resources used by the UE 704 to receive RF signals from the repeater 706-1 (i.e., MT₁); (f, t)_{2,2} indicates the resources used by the UE 704 to receive RF signals from the repeater 706-2 (i.e., MT₂), and so on. In certain configurations, (f,t)₁, (f, t)_{2,1}, (f, t)_{2,2}, . . . and (f, t)_{2,K} are orthogonal. In particular, they do not overlap in frequency domain. In certain configurations, (f, t)₁ may be the same as one (f, t)_{2,k} (k∈1, . . . K), while the rest are orthogonal to each other. Further, (f, t)₁ and (f, t)_{2,k} (1≤k≤K) can be non-overlapped component carriers, non-overlapped bandwidth parts (BWPs), non-overlapped frequency bands, or non-overlapped collections within the same component carrier. To provide sufficient time for decoding the first PDSCH at the repeaters, (f, t)_{2,k} is typically after (f, t)₁.

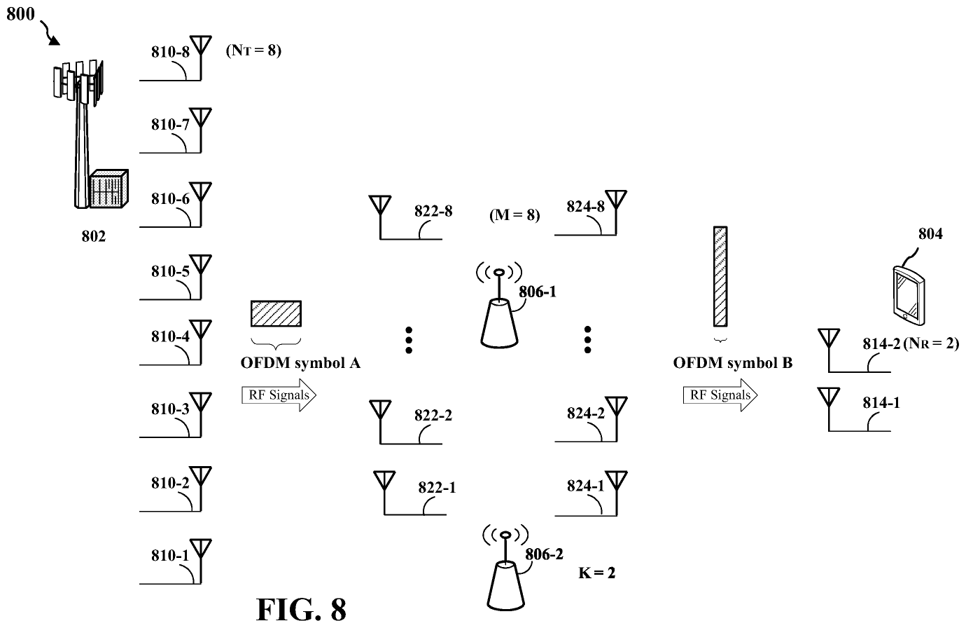

FIG. 8 is a diagram 800 illustrating downlink MIMO transmission from a base station to a UE via one or more repeaters. In this example, a base station 802 has 8 antennas 810-1, 810-2, . . . 810-8, and a UE 804 has 2 reception antennas 814-1, 814-2. Further, repeaters 806-1, 806-2, . . . , 806-K are placed between the base station 802 and the UE 804. Each of the repeaters 806-1, 806-2, . . . , 806-K has 8 reception antennas 822-1, 822-2, . . . , 822-8 and 8 transmission antennas 824-1, 824-2, . . . , 824-8. In certain configurations, the same antenna may function as a reception antenna and a transmission antenna. The base station 802 can simultaneously transmit signals to the repeaters 806-1, 806-2, . . . , 806-K at the time-frequency resource (f, t)₁. The repeaters 806-1, 806-2, . . . , 806-K can simultaneously transmit signals to the UE 804 at the time-frequency resource (f, t)_{2,1}, (f, t)_{2,2}, . . . , (f, t)_{2,K} respectively. The time-frequency resource (f, t)₁, (f, t)_{2,1}, (f, t)_{2,2}, . . . and (f, t)_{2,K} can be in the same component carrier (CC), bandwidth parts (BWP) or frequency band. The time-frequency resource (f, t)₁, (f, t)_{2,1}, (f, t)_{2,2}, . . . and (f, t)_{2,K} can be in two non-overlapped CCs, two non-overlapped BWPs or two non-overlapped frequency bands. Subcarrier spacing (SCS) used in the first time-frequency resource (f, t)₁ could be different from that in second time-frequency resource (f, t)_{2,1}, (f, t)_{2,2}, . . . , (f, t)_{2,K}. In this example, the first time-frequency resource (f, t)₁ is within a band in FR1 and is associated with SCS₁=30 kHz, the second time-frequency resource (f, t)_{2,1}, (f, t)_{2,2}, . . . , (f, t)_{2,K} are within a band in FR2 and is associated with SCS₂=120 kHz. In this example, TTI length with SCS₁ is four times TTI length with SCS₂. In this example, K=2.

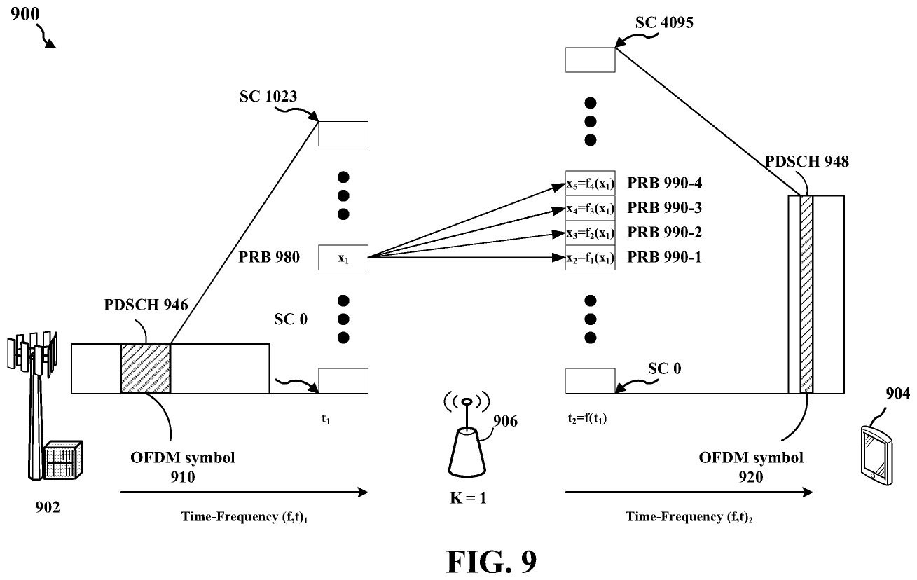

FIG. 9 is a diagram 900 illustrating a mapping rule that maps resource allocation (RA) on a first time-frequency resource to RA on a second time-frequency resource. More specifically, the mapping maps a first time-frequency resource (f, t)₁ to a second time-frequency resource (f, t)₂. The mapping can be located in time domain, frequency domain or in time-frequency domain.

In this example, a repeater 906 is placed between a base station 902 and a UE 904. The base station 902 transmits to the repeater 906 a PDSCH 946 carried on the first time-frequency resource (f, t)₁. The repeater 906 demodulates and decodes the PDSCH 946 to obtain the original information bits. Further, the repeater 906 re-encodes and modulates the original information bits to obtain modulation symbols to be carried in a PDSCH 948 on the second time-frequency resource (f, t)₂ according to the mapping rule. The mapping rule translates the resource allocation of the first time-frequency resource (f, t)₁ used by the PDSCH 946 to the resource allocation of the second time-frequency resource (f, t)₂ used by the PDSCH 948. For example, suppose a physical resource block (PRB) 980 with index x₁ at time t₁ is allocated for the PDSCH 946. The mapping rule defines how this PRB 980 is mapped to one or more PRBs for the PDSCH 948.

Three examples of the mapping rule are:
1) Mapping in frequency domain: The index x₂ of the mapped PRB 990 in PDSCH 948 is determined as x₂=g(x₁), where g(x₁) is a mapping function from x₁ to x₂.
2) Mapping in time domain: The time t₂ of the mapped PRB 990 in PDSCH 948 is determined as t₂=g(t₁), where g(t₁) is a mapping function from t₁ to t₂. For example, g(t₁) can be a constant offset, e.g., g(t₁)=t₁+offset.
3) Mapping in time-frequency domain: The index x₂ and time t₂ of the mapped PRB 990 in PDSCH 948 are determined as (x₂, t₂)=g(x₁, t₁), where g(x₁, t₁) maps (x₁, t₁) to (x₂, t₂).

The mapping can be one-to-one or one-to-multiple. In one example, the base station 902 transmits PDSCH 946 using 1024 subcarriers with subcarrier spacing (SCS) SCS₁=30 kHz. The repeater 906 transmits PDSCH 948 using 4096 subcarriers with SCS₂=120 kHz. Each PRB in PDSCH 946 maps to 4 PRBs in PDSCH 948. A PRB 980 in PDSCH 946 at (x₁, t₁) may be mapped to PRBs 990-1 at (x₂, t₂) per g₁, 990-2 at (x₃, t₂) per g₂, 990-3 at (x₄, t₂) per g₃, and 990-4 at (x₅, t₂) per g₄ in PDSCH 948. In other words, one PRB 980 in PDSCH 946 may be mapped to multiple PRBs 990-1, 990-2, 990-3, 990-4 in PDSCH 948 according to multiple mapping functions g₁, g₂, g₃, g₄.

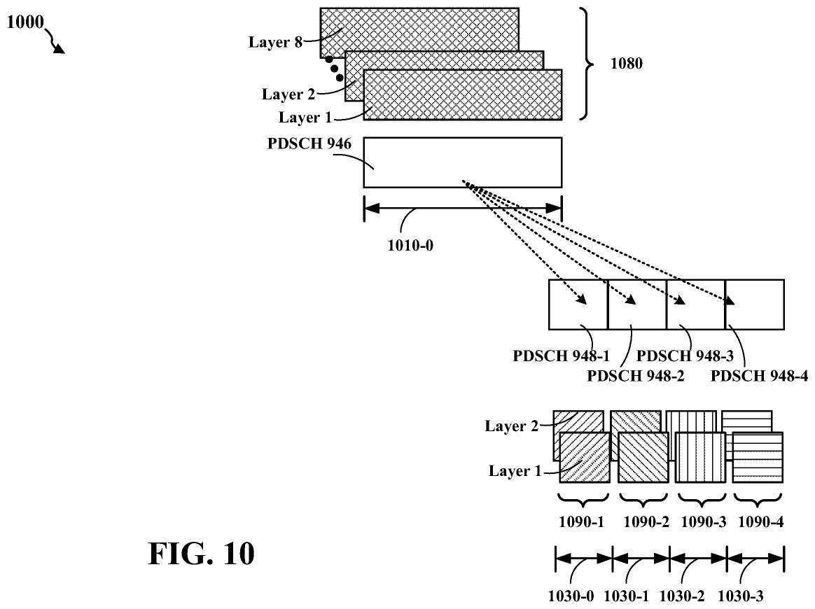

FIG. 10 is a diagram 1000 illustrating a mapping rule that maps data transmission in a first PDSCH to data transmission in a second PDSCH. In this example, the base station 902 transmits a PDSCH 946 carrying a transport block (TB) 1080 to the repeater 906 in a slot 1010-0 on f₁. The PDSCH 946 is transmitted using 8 transmission antennas of the base station 902. The TB 1080 contains data corresponding to 8 spatial layers. The slot 1010-0 has a duration of TTI₁ (e.g., 0.5 ms) based on a first subcarrier spacing SCS₁ (e.g., 30 kHz).

The repeater 906 receives the PDSCH 946 using 8 reception antennas on f₁. The repeater 906 decodes the modulated symbols to obtain the information bits carried in TB 1080. It then re-encodes the information bits to generate 4 TBs 1090-1, 1090-2, 1090-3 and 1090-4, each containing 2 spatial layers of data from the original 8 spatial layers.

The repeater 906 transmits the 4 TBs using 2 transmission antennas in slots 1030-0, 1030-1, 1030-2 and 1030-3 on f₂, through PDSCHs 948-1, 948-2, 948-3 and 948-4 respectively. The slots 1030-0 to 1030-3 have a duration of TTI₂ (e.g., 0.125 ms) based on a second subcarrier spacing SCS₂ (e.g., 120 kHz). In this example, TTI₁ is 4 times TTI₂, and SCS₂ is 4 times SCS₁. The repeater may transmit TB 1090-1 (containing first 2 spatial layers of data) in PDSCH 948-1 in slot 1030-0, TB 1090-2 (containing next 2 spatial layers of data) in PDSCH 948-2 in slot 1030-1, and so on until all 8 spatial layers have been transmitted over 4 slots.

The resource allocation (RA) of the PDSCHs 948-1 to 948-4 is determined based on a mapping rule as described in FIG. 9. For example, if a certain PRB is allocated for PDSCH 946, the mapping rule defines how that PRB maps to one or more PRBs for the PDSCHs 948-1 to 948-4.

When transmitting the PDSCHs 948-1 to 948-4, the repeater 906 also needs to generate corresponding reference signals (e.g., DMRS, TRS, PTRS) along with each PDSCH for the UE 904 to estimate channel parameters. Subcarriers occupied by these reference signals are reserved and cannot be used to carry the encoded bits of the PDSCHs. The configurations for generating these reference signals to be transmitted on the second time-frequency resources (f, t)₂ should be provided from the network.

The encoded bits of the TBs 1090-1 to 1090-4 are mapped to modulation symbols which are then mapped to the available subcarriers in the PDSCHs 948-1 to 948-4. The modulation symbols may be punctured or rate matched around the reserved subcarriers occupied by reference signals. Puncturing means the repeater 906 maps the encoded bits sequentially to modulation symbols, but skips mapping to subcarriers that are reserved. The encoded bits corresponding to the reserved subcarriers are discarded. Rate matching means the repeater 906 maps the encoded bits sequentially but skips over reserved subcarriers to the next available subcarrier. The encoded bits are not discarded. Thus, only the subcarriers that are not reserved for reference signals can be used to carry the modulation symbols containing encoded bits for the PDSCHs 948-1 to 948-4.

By decoding the PDSCH 946 and re-encoding for transmission, the repeater 906 can remove any interference present in the received signals from the base station 902. The mapping rule allows the repeater 906 to determine the resource allocation for transmitting the PDSCHs 948-1 to 948-4 immediately after decoding the control information, without needing additional scheduling delays.

As described supra, the PDSCH 946-1 and the PDSCHs 948-1, 948-2, 948-3 and 948-4 carry the identical information bits. The encoded bits of the PDSCH 946-1 and the encoded bits of the PDSCHs 948-1, 948-2, 948-3 and 948-4 are both derived from the same set of the information bits.

However, the encoded bits of the PDSCH 946-1 may not be the same as the encoded bits of the PDSCHs 948-1, 948-2, 948-3 or 948-4 because of different code rates or modulation schemes. The repeater 906 may use a different modulation and coding scheme (MCS) to re-encode the information bits for the PDSCHs 948-1, 948-2, 948-3 and 948-4 compared to the MCS used for PDSCH 946-1.

The mapping rule may imply to follow the same modulation order as that of the PDSCH 946-1. Alternatively, the mapping rule may imply adjustments to the channel coding rule, code rate, or modulation order from the PDSCH 946-1 to the PDSCHs 948-1, 948-2, 948-3 and 948-4.

The mapping rule is pre-defined so that the encoding of the second PDSCH can start right after knowing coding and layer-mapping information of the first PDSCH. As described supra, the repeater 906 receives the PDSCH 946 from the base station 902 on the first time-frequency resource (f, t)₁. The PDSCH 946 contains a transport block (TB) 1080 spanning 8 spatial layers.

The repeater 906 can decode the PDCCH 942 transmitted prior to the PDSCH 946 to determine the resource allocation for the PDSCH 946, such as which PRBs are occupied by the PDSCH 946. This resource allocation information for the first PDSCH 946 also allows the repeater 906 to determine the resource allocation for the second PDSCHs 948-1 to 948-4 based on the pre-defined mapping rule.

For example, if the mapping rule specifies that PRB #x in the first PDSCH 946 maps to 4 PRBs starting from PRB #x in the second PDSCHs 948, then upon decoding the PDCCH 942, the repeater 906 can immediately determine the corresponding PRBs in the second PDSCHs 948-1 to 948-4.

Right after knowing coding and layer-mapping information of the PDSCH 946-1, the repeater 906 can re-encode the original information bits to generate the TB 1090-1, 1090-2, 1090-3 and 1090-4, which are transmitted through the PDSCHs 948-1, 948-2, 948-3 and 948-4 on the time and frequency resource (f, t)².

Each TB 1090-1 to 1090-4 contains data for 2 spatial layers from the original 8 spatial layers in TB 1080. By starting the encoding process as soon as the resource allocation is known from the mapping rule, the repeater 906 can reduce processing delays compared to waiting until the entire PDSCH 946-1 is decoded before determining the parameters for PDSCHs 948-1 to 948-4.

As another example, after determining code-rate, modulation order, the number of spatial layers, and the number of TTIs to be used for the second PDSCH, the repeater 906 re-encodes data extracted from the original 8 spatial layers in TB 1080 to form modulated symbols to be carried by the second PDSCH. The repeater then maps the modulated symbols to resource elements (REs) in the second PDSCH in a specific order in time, frequency and spatial domain. For example, assuming that the second PDSCH is to occupy 4 TTIs and in each TTI there are two spatial layers, the repeater 906 can map encoded bits in a “spatial-domain first, time-domain second, and frequency-domain third” order to the REs of the second PDSCH. For example, in the first RE, the repeater may map 2 modulated symbols corresponding to 2 layers. Then the repeater map next 2 modulated symbols to a next RE, which is adjacent to the previous RE in frequency domain (in the next subcarrier). The repeater continues the process above until all un-occupied REs in one time-domain OFDM symbol of the second PDSCH are all mapped, and then continues the process in the next time-domain OFDM symbol until all OFDM symbols in the 4 TTIs belonging to the second PDSCH are all mapped.

In certain configurations, the base station 902 transmits configurations defining the mapping rule to the repeater 906. In certain configurations, the mapping rule depends on the MAC layer and/or PHY layer of the repeater 906. The re-encoded bits are provided to the MAC layer and/or PHY layer of the repeater 906. The MAC layer and/or PHY layer then determines how to modulates the re-encoded bits and place the modulation symbols into the PDSCHs 948-1, 948-2, 948-3 and 948-4.

To achieve high rank transmission beyond the typical rank limit (e.g., rank 8) of a single repeater/relay device to a single UE, a base station may use multiple repeater devices (e.g., 2 devices) and transmit to them simultaneously using MU-MIMO on (f, t)₁ (e.g., FR1). For example, the base station can transmit 16 total layers of data to 2 repeater devices, with each device receiving 8 layers in the first hop.

The repeaters then forward their received layers to the UE in the second hop on (f, t)₂ (e.g., FR2). However, the transmission rank is limited in FR2, so each repeater can only transmit, as an example, 2 layers per TTI. By having each repeater transmit its received layers over multiple TTIs (e.g. 4 TTIs) and coordinating across the 2 relays, the UE can still receive up to 16 total layers over time, even though each TTI is rank limited. This provides a high rank connection to a single UE beyond the typical limit of a single repeater.

From the UE perspective, it is receiving layers from multiple repeaters in a SDM, TDM, or FDM manner over multiple TTIs. The UE needs to know the resource allocation and other parameters for receiving from each relay correctly.

The base station coordinates this multi-relay transmission by allocating resources for each repeater in both the first hop (base station to repeaters) and second hop (repeaters to UE). It can use different techniques such as SDM, TDM, and FDM in the second hop. By coordinating the transmissions in this way, the end-to-end rank and capacity to a single UE can be increased beyond traditional limits.

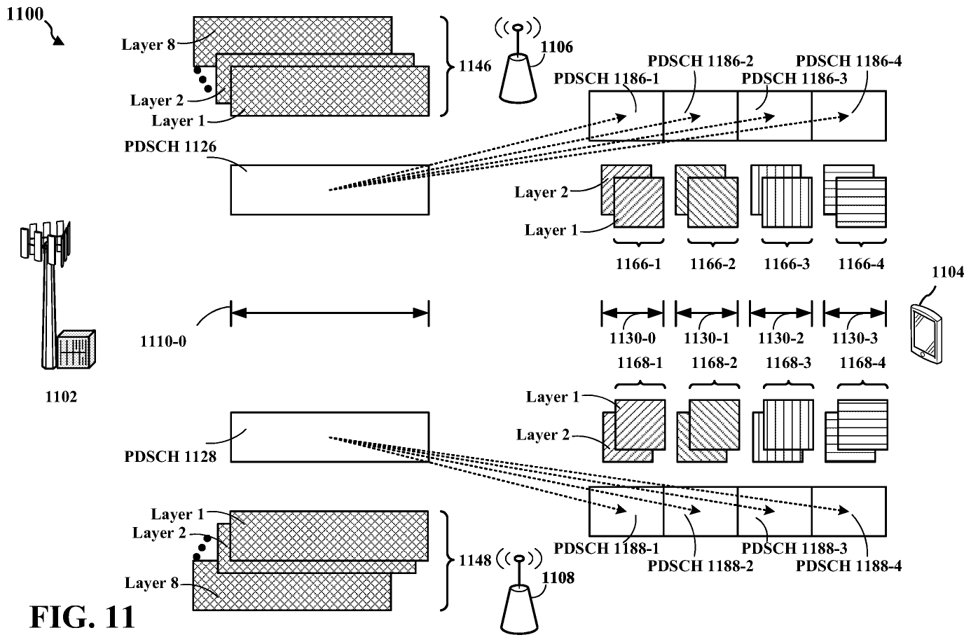

FIG. 11 is a diagram 1100 illustrating a MIMO transmission of repeaters using a space-division multiplexing (SDM) configuration or a frequency division multiplexing (FDM) configuration. A base station 1102 has high rank data to be transmitted to the UE 1104. In this example, the base station 1102 may have 16 layers data to be transmitted.

The base station 1102 prepares a PDSCH 1126 carrying a transport block (TB) 1146. The TB 1146 contains 8 layers of data. The base station 1102 prepares a PDSCH 1128 carrying a TB 1148. The TB 1148 carries another 8 layers of data. The base station 1102 transmits the PDSCH 1126 to a repeater 1106 in a slot 1110-0 on (f, t)₁ through a first set of antennas. The base station 1102 transmits the PDSCH 1128 to a repeater 1108 in the slot 1110-0 through a second set of antennas. For example, each set of the first set and the second set may contain 8 transmission antennas. As another example, the base station 1102 is equipped with 16 transmission antennas and transmits the PDSCH 1126 to a repeater 1106 in a slot 1110-0 on (f, t)₁ by a first rank-8 precoder. The base station 1102 transmits the PDSCH 1128 to a repeater 1108 in the slot 1110-0 on (f, t)₁ by a second rank-8 precoder. The slot 1110-0 has a duration of TTI₁ (e.g., 0.5 ms) based on a first subcarrier spacing SCS₁ (e.g., 30 kHz).

The repeater 1106 receives the PDSCH 1126 using 8 reception antennas on (f, t)₁. The repeater 1106 decodes the modulated symbols to obtain the information bits carried in the TB 1146, which contains the original 8 layers of data. It then re-encodes the information bits to generate 4 TBs 1166-1, 1166-2, 1166-3 and 1166-4, each containing 2 layers of data from the original 8 layers.

Similarly, the repeater 1108 receives the PDSCH 1128 using 8 reception antennas on (f, t)₁. The repeater 1108 decodes the modulated symbols to obtain the information bits carried in TB 1148, which contains the other original 8 layers of data. It then re-encodes the information bits to generate 4 TBs 1168-1, 1168-2, 1168-3 and 1168-4, each containing 2 layers of data from the original 8 layers.

The repeater 1106 transmits the 4 TBs using 2 transmission antennas in slots 1130-0, 1130-1, 1130-2 and 1130-3 on (f, t)₂, through PDSCHs 1186-1, 1186-2, 1186-3 and 1186-4 respectively. The repeater 1108 transmits the 4 TBs using 2 transmission antennas in slots 1130-0, 1130-1, 1130-2 and 1130-3 on (f, t)₂, through PDSCHs 1188-1, 1188-2, 1188-3 and 1188-4 respectively.

The slots 1130-0 to 1130-3 have a duration of TTI₂ (e.g., 0,125 ms) based on a second subcarrier spacing SCS₂ (e.g., 120 kHz). In this example, TTI₁ is 4 times TTI₂, and SCS₂ is 4 times SCS₁. The repeater 1106 and the repeater 1108 may transmit TB 1166-1 (containing first 2 spatial layers of data) through PDSCH 1186-1 and TB 1168-1 (containing first 2 spatial layers of data) through PDSCH 1188-1 respectively in slot 1130-0, TB 1166-2 (containing next 2 spatial layers of data) through PDSCH 1186-2 and TB 1168-2 (containing next 2 spatial layers of data) through PDSCH 1188-2 in slot 1130-1, and so on until all 8 spatial layers have been transmitted over 4 slots. The resource allocation (RA) of the PDSCHs 1186-1 to 1186-4 and the PDSCHs 1188-1 to 1188-4 is determined based on a mapping rule similar to that described in FIG. 9.

The UE 1104 receives, using 4 reception antennas, the TB 1166-1 (containing first 2 spatial layers of data) through the PDSCH 1186-1 from the repeater 1106 and the TB 1168-1 (containing first 2 spatial layers of data) through the PDSCH 1166-1 from the repeater 1108 in the slot 1130-0. Subsequently, the UE 1104 receives the TB 1166-2 (containing second 2 spatial layers of data) through the PDSCH 1186-2 from the repeater 1106 and the TB 1168-2 (containing second 2 spatial layers of data) through the PDSCH 1188-2 from the repeater 1108 in the slot 1130-1, and so on until all 8 spatial layers have been received over 4 slots.

The base station 1102 includes information about the second time-frequency resource allocation in the control signaling it sends to both repeaters 1106 and 1108. This information could be in the form of resource blocks (RBs) or subcarriers allocated for each repeater 1106 and 1108. The repeater 1106 and the repeater 1108, upon receiving the resource allocation information from the base station 1102, know which time-frequency resources they should use for their respective transmissions to the UE 1104. The UE 1004 needs to be aware of the resource allocation made to the repeaters 1106 and 1108. This information can be included in higher-layer signaling, dynamic control signaling, or broadcasted system information, so that the UE 1104 knows which time-frequency resources to monitor for repeater transmissions. The UE 1104, based on the signaling it received, knows when and where to listen for data from the repeaters 1106 and 1108, and/or how to beamform to receive signal from the repeaters 1106 and 1108, e.g., QCL assumptions related to the two repeaters. It monitors the specified time-frequency resources for transmissions from the repeaters 1106 and 1108. The repeaters 1106 and 1108 transmit the relayed data to the UE 1104 on the allocated time-frequency resources as directed by the base station 1102. The UE 1104 receives the relayed data on the specified resources and processes it accordingly.

Further, in certain configurations, instead of using SDM as the example presented above, the repeater 1106 and the repeater 1108 may use FDM to forward the data to the UE 1104. As described supra, the base station 1102 has 16 layers of data to transmit to the UE 1104. The base station 1102 transmits a PDSCH 1126 carrying a transport block (TB) 1146 with 8 layers to repeater 1106. The base station 1102 also transmits a PDSCH 1128 carrying a TB 1148 with 8 layers to repeater 1108. The transmission to each repeater uses the full bandwidth in the first hop.

The repeater 1106 receives PDSCH 1126 and decodes TB 1146 to obtain the 8 layers. It splits these into 4 TBs 1166-1, 1166-2, 1166-3, 1166-4, with each TB containing 2 layers. Similarly, repeater 1108 receives PDSCH 1128 and decodes TB 1148 to obtain 8 layers. It splits these into 4 TBs 1168-1, 1168-2, 1168-3, 1168-4, each with 2 layers.

In the second hop, the base station 1102 allocates non-overlapping frequency bands on (f, t)₂ (e.g., FR2) to each repeater. For example, the base station 1102 allocates frequency band 1 to the repeater 1106 and allocates frequency band 2 to the repeater 1108.

The second hop transmissions utilize shorter TTIs (e.g., 0.125 ms) duration across 4 slots 1130-0 to 1130-3, as described supra. In each slot, the repeater 1106 transmits one TB in frequency band 1 while simultaneously repeater 1108 transmits one TB in frequency band 2. For example, in slot 1130-0, the repeater 1106 sends TB 1166-1 in band 1 while the repeater 1108 sends TB 1168-1 in band 2. This continues until all 4 TBs from each repeater have been transmitted over the 4 slots.

At the UE 1104, the TBs transmitted in frequency band 1 are received and combined to reconstruct the original 8 layers from repeater 1106. Similarly, the TBs in frequency band 2 are combined to obtain the 8 layers from repeater 1108. By allocating separate frequency bands to each repeater and coordinating the transmissions, frequency division multiplexing (FDM) is achieved in the second hop. This allows the UE to ultimately receive the complete set of 16 layers across the two frequency bands from the multiple coordinated repeaters.

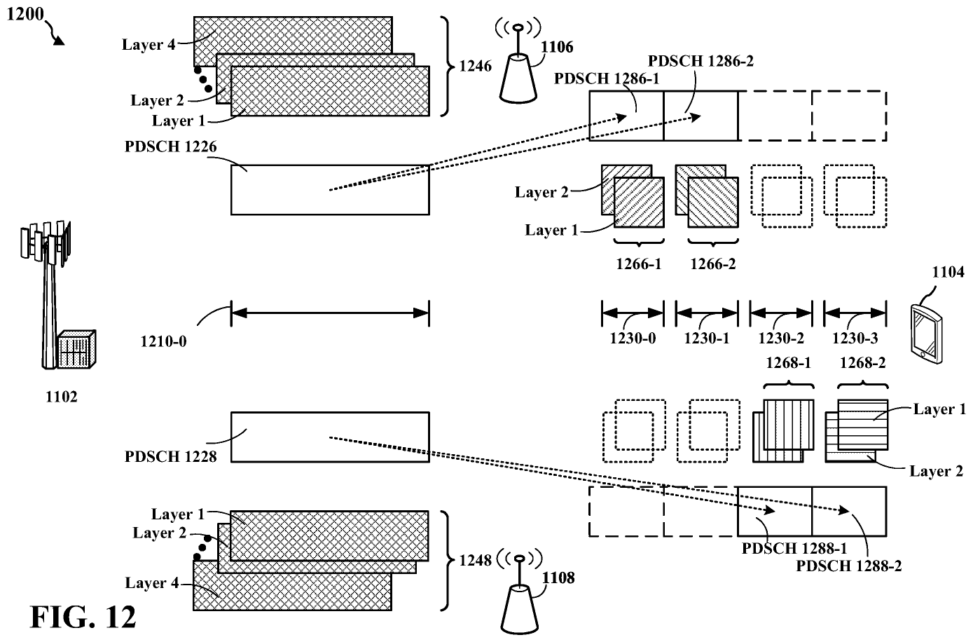

FIG. 12 is a diagram 1200 illustrating a MIMO transmission using a time-division multiplexing (TDM) configuration. In this example, the base station 1102 has high rank data to be transmitted to the UE 1104. In this example, the base station 1102 may have 8 layers data to be transmitted.

The base station 1102 prepares a PDSCH 1226 carrying a transport block (TB) 1246. The TB 1246 contains 4 layers of data. The base station 1102 prepares a PDSCH 1228 carrying a TB 1248. The TB 1248 carries another 4 layers of data. The base station 1102 transmits the PDSCH 1226 to a repeater 1106 in a slot 1210-0 on (f, t)₁ through a first set of antennas. The base station 1102 transmits the PDSCH 1228 to a repeater 1108 in the slot 1210-0 through a second set of antennas. For example, each set of the first set and the second set may contain 4 transmission antennas. The slot 1210-0 has a duration of TTI₁ (e.g., 0.5 ms) based on a first subcarrier spacing SCS₁ (e.g., 30 kHz).

The repeater 1106 receives the PDSCH 1226 using 4 reception antennas on (f, t)₁. The repeater 1106 decodes the modulated symbols to obtain the information bits carried in the TB 1246, which contains the original 4 layers of data. It then re-encodes the information bits to generate 2 TBs 1266-1, 1266-2, each containing 2 layers of data from the original 4 layers.

Similarly, the repeater 1108 receives the PDSCH 1228 using 4 reception antennas on (f, t)₁. The repeater 1108 decodes the modulated symbols to obtain the information bits carried in TB 1248, which contains the other original 4 layers of data. It then re-encodes the information bits to generate 2 TBs 1268-1, 1268-2, each containing 2 layers of data from the original 4 layers.

The repeater 1106 transmits the 2 TBs using 2 transmission antennas in slots 1230-0, and 1230-1 on (f, t)₂, through PDSCHs 1286-1 and 1286-2 respectively. The repeater 1108 transmits the 2 TBs using 2 transmission antennas in slots 1230-2 and 1230-3 on (f, t)₂, through PDSCHs 1288-1 and 1288-2 respectively. The slots 1230-0 to 1230-3 have a duration of TTI₂ (e.g., 0.125 ms) based on a second subcarrier spacing SCS₂ (e.g., 120 kHz). In this example, TTI₁ is 4 times TTI₂, and SCS₂ is 4 times SCS₁. The repeater 1106 may transmit TB 1266-1 (containing first 2 spatial layers of data) through PDSCH 1286-1 in slot 1230-0) and TB 1266-2 (containing second 2 spatial layers of data) through PDSCH 1286-2 in slot 1230-1. The repeater 1108 may transmit TB 1268-1 (containing first 2 spatial layers of data) through PDSCH 1288-1 in slot 1230-2 and TB 1268-2 (containing next 2 spatial layers of data) in PDSCH 1288-2 in slot 1230-3.

The resource allocation (RA) of the PDSCHs 1286-1, 1286-2, 1288-1 and 1288-2 is determined based on a mapping rule similar to that described in FIG. 9.

The UE 1104 receives the TB 1266-1 (containing first 2 spatial layers of data) using 2 reception antennas through the PDSCH 1286-1 in the slot 1230-0) and the TB 1266-2 (containing second 2 spatial layers of data) through the PDSCH 1286-2 in the slot 1230-1 from the repeater 1106. The UE 1104 receives the TB 1268-1 (containing first 2 spatial layers of data) using 2 reception antennas through the PDSCH 1288-1 in the slot 1230-2 and the TB 1268-2 (containing second 2 spatial layers of data) through the PDSCH 1288-2 in the slot 1230-3 from the repeater 1108.

The base station 1102 needs to coordinate the transmissions from the repeater 1106 and repeater 1108 to the UE 1104. The base station 1102 transmits control information to the repeater 1106 and 1108 indicating the resource allocation (RA) each should use to receive data from the base station 1102 in the first hop. This is the allocation in the first time-frequency resource between the base station and the repeaters. The control information from the base station 1102 also indicates the resource allocation the repeater 1106 and repeater 1108 should each use for forwarding the data to the UE 1104 in the second hop. This is the allocation in the second time-frequency resource between the repeaters and the UE 1104.

For example, the base station 1102 can allocate different time slots or frequency resources to the repeater 1106 and repeater 1108 in the second hop using TDM or FDM techniques. This prevents interference between their transmissions to the UE 1104. Alternatively, the base station 1102 can allocate overlapping resources to both relays in the second hop using SDM and rely on spatial separation for the UE 1104 to distinguish between them. By specifying both the first hop and second hop resource allocations for the repeater 1106 and repeater 1108, the base station 1102 coordinates the overall multi-relay transmission to achieve the high rank connection to the single UE 1104. The repeaters follow the resource allocations indicated by the base station.

In addition to knowing the resource allocation, the UE 1104 may need to obtain other control information from the base station 1102 related to each relay transmission.

For example, the UE 1104 may need beamforming configuration information or parameters associated with each relay transmission, such as beam direction, beamforming weights or codebook index. The UE 1104, based on the information, may steer its receive beams towards each repeater to correctly receive the multi-antenna transmission.

Additionally, the UE 1104 may need Quasi-co-location (QCL) information from the base station for each relay transmission. QCL info helps the UE 1104 determine channel correlations across time/frequency/spatial domains when receiving multiple relay transmissions.

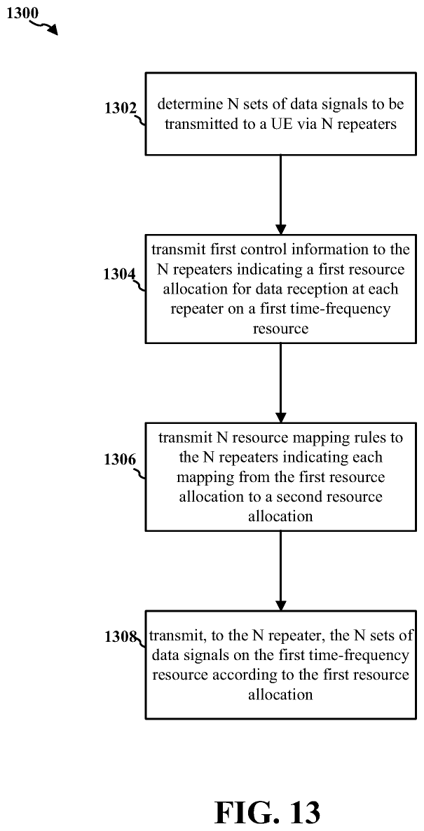

FIG. 13 is a flow chart 1300 of a method (process) for transmitting data signals. The method may be performed by a base station (e.g., the base station 210). In operation 1302, the base station determines N sets of data signals to be transmitted to a user equipment (UE) via N repeaters. Each set of the N sets of data signals is associated with each of the N repeaters and carries data of a plurality of layers, N being an integer greater than 1.

In operation 1304, the base station transmits first control information to the N repeaters indicating a first resource allocation for data reception at each repeater on a first time-frequency resource. In operation 1306, the base station transmits N resource mapping rules to the N repeaters indicating each mapping from the first resource allocation to a second resource allocation for forwarding each of the N sets of data signals, received at each repeater on the first time-frequency resource, on a second time-frequency resource. The second resource allocations for the N repeater are non-overlapping in at least one of time domain, frequency domain, and spatial domain. In operation 1308, the base station transmits, to the N repeater, the N sets of data signals on the first time-frequency resource according to the first resource allocation.

In certain configurations, the N resource mapping rules are transmitted via a control channel shared by the N repeaters or via configuring before the transmission of the N sets of data signals. In certain configurations, the first control information is transmitted to the N repeaters via a control channel shared by the N repeaters or via individual control channels of the N repeaters.

In certain configurations, the base station further transmits second control information to the UE indicating information used for decoding the N sets of data signals transmitted by the base-station and forwarded by the N repeaters. In certain configurations, the N resource mapping rules are based on a predefined mapping rule.

In certain configurations, the first time-frequency resource is in FR1 and the second time-frequency resource is FR2. In certain configurations, a subcarrier spacing on the first time-frequency resource is smaller than a subcarrier spacing on the second time-frequency resource. In certain configurations, a transmission time interval duration on the first time-frequency resource is larger than a transmission time interval duration on the second time-frequency resource.

In certain configurations, the plurality of layers include more layers than that the UE is capable of decoding in one transmission time interval (TTI) in the second time-frequency resource. In certain configurations, each of the N repeaters spreads a corresponding set of layers over multiple TTIs for transmission on the second time-frequency resource based on a number of layers that the UE is capable of decoding per TTI on the second time-frequency resource.

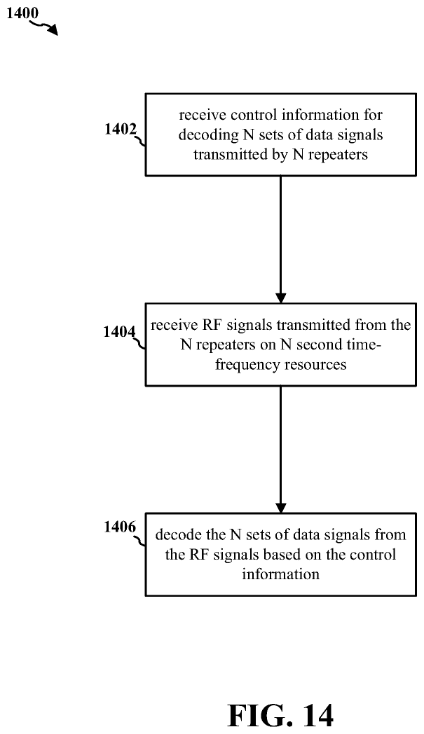

FIG. 14 is a flow chart 1400 of a method (process) for decoding data signals. The method may be performed by a UE (e.g., the UE 704, the UE 250). In operation 1402, the UE receives control information for decoding N sets of data signals transmitted by N repeaters. Each set of the N sets of data signals is associated with a respective one of the N repeaters, N being an integer greater than 1. In operation 1404, the UE receives RF signals transmitted from the N repeaters on N second time-frequency resources. In operation 1406, the UE decodes the N sets of data signals from the RF signals based on the control information.

In certain configurations, the N sets of data signals are originated from a base station and are transmitted by the base station simultaneously on a first time-frequency resource. Each of the N repeaters receives a respective set of data signals on the first time-frequency resource, decodes the respective set of data signals, generates and transmits RF signals carrying the respective set of data signals to the UE on a respective one of the N second time-frequency resources. In certain configurations, the N second time-frequency resources are non-overlapping in time, frequency, or spatial domain.

In certain configurations, the control information used for decoding the N sets of data signals includes at least one of an indication of the N second time-frequency resources and quasi-co-location (QCL) information on the N second time-frequency resources. In certain configurations, the control information used for decoding the N sets of data signals includes an indication of the first time-frequency resource and mapping rules mapping the first time-frequency resources to the N second time-frequency resources.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a base station, comprising:
determining N sets of data signals to be transmitted to a user equipment (UE) via N repeaters, wherein each set of the N sets of data signals is associated with each of the N repeaters and carries data of a plurality of layers, N being an integer greater than 1:
transmitting first control information to the N repeaters indicating a first resource allocation for data reception at each repeater on a first time-frequency resource:
transmitting N resource mapping rules to the N repeaters indicating each mapping from the first resource allocation to a second resource allocation for forwarding each of the N sets of data signals, received at each repeater on the first time-frequency resource, on a second time-frequency resource, wherein the second resource allocations for the N repeater are non-overlapping in at least one of time domain, frequency domain, and spatial domain; and
transmitting, to the N repeater, the N sets of data signals on the first time-frequency resource according to the first resource allocation.

2. The method of claim 1, wherein the N resource mapping rules are transmitted via a control channel shared by the N repeaters or via configuring before the transmission of the N sets of data signals.

3. The method of claim 1, wherein the first control information is transmitted to the N repeaters via a control channel shared by the N repeaters or via individual control channels of the N repeaters.

4. The method of claim 1, further comprising:
transmitting second control information to the UE indicating information used for decoding the N sets of data signals transmitted by the base-station and forwarded by the N repeaters.

5. The method of claim 1, wherein the N resource mapping rules are based on a predefined mapping rule.

6. The method of claim 1, wherein the first time-frequency resource is in FR1 and the second time-frequency resource is FR2.

7. The method of claim 1, wherein a subcarrier spacing on the first time-frequency resource is smaller than a subcarrier spacing on the second time-frequency resource.

8. The method of claim 1, wherein a transmission time interval duration on the first time-frequency resource is larger than a transmission time interval duration on the second time-frequency resource.

9. The method of claim 1, wherein the plurality of layers comprises more layers than that the UE is capable of decoding in one transmission time interval (TTI) in the second time-frequency resource.

10. The method of claim 9, wherein each of the N repeaters spreads a corresponding set of layers over multiple TTIs for transmission on the second time-frequency resource based on a number of layers that the UE is capable of decoding per TTI on the second time-frequency resource.

11. A method of wireless communication of a user equipment (UE), comprising:
receiving control information for decoding N sets of data signals transmitted by N repeaters, wherein each set of the N sets of data signals is associated with a respective one of the N repeaters, N being an integer greater than 1:
receiving RF signals transmitted from the N repeaters on N second time-frequency resources; and
decoding the N sets of data signals from the RF signals based on the control information.

12. The method of claim 11, wherein the N sets of data signals are originated from a base-station and are transmitted by the base-station simultaneously on a first time-frequency resource, wherein each of the N repeaters receives a respective set of data signals on the first time-frequency resource, decodes the respective set of data signals, generates and transmits RF signals carrying the respective set of data signals to the UE on a respective one of the N second time-frequency resources.

13. The method of claim 12, wherein the N second time-frequency resources are non-overlapping in time, frequency, or spatial domain.

14. The method of claim 12, wherein the control information used for decoding the N sets of data signals includes at least one of an indication of the N second time-frequency resources and quasi-co-location (QCL) information on the N second time-frequency resources.

15. The method of claim 12, wherein the control information used for decoding the N sets of data signals includes:
an indication of the first time-frequency resource; and
mapping rules mapping the first time-frequency resources to the N second time-frequency resources.

16. An apparatus for wireless communication, the apparatus being a base station, comprising:
a memory; and
at least one processor coupled to the memory and configured to:
determine N sets of data signals to be transmitted to a user equipment (UE) via N repeaters, wherein each set of the N sets of data signals is associated with each of the N repeaters and carries data of a plurality of layers, N being an integer greater than 1;
transmit first control information to the N repeaters indicating a first resource allocation for data reception at each repeater on a first time-frequency resource;
transmit N resource mapping rules to the N repeaters indicating each mapping from the first resource allocation to a second resource allocation for forwarding each of the N sets of data signals, received at each repeater on the first time-frequency resource, on a second time-frequency resource, wherein the second resource allocations for the N repeater are non-overlapping in at least one of time domain, frequency domain, and spatial domain; and
transmit, to the N repeater, the N sets of data signals on the first time-frequency resource according to the first resource allocation.

17. The apparatus of claim 16, wherein the at least one processor is further configured to transmit the N resource mapping rules via a control channel shared by the N repeaters or via configuring before the transmission of the N sets of data signals.

18. The apparatus of claim 16, wherein the at least one processor is further configured to transmit the first control information to the N repeaters via a control channel shared by the N repeaters or via individual control channels of the N repeaters.

19. The apparatus of claim 16, wherein the at least one processor is further configured to:
transmit second control information to the UE indicating information used for decoding the N sets of data signals transmitted by the base station and forwarded by the N repeaters.

20. The apparatus of claim 16, wherein the N resource mapping rules are based on a predefined mapping rule.
